(19) United States
(12) Patent Application Publication
(10) Pub. No.: US 2015/0096500 A1
(43) Pub. Date: Apr. 9, 2015

(54) Mobile Electronic Call and Decoy Device

(71) Applicant: Steven Quinn McCain, Littlefield, TX (US)

(72) Inventor: Steven Quinn McCain, Littlefield, TX (US)

(21) Appl. No.: 14/503,493

(22) Filed: Oct. 1, 2014

Related U.S. Application Data
(60) Provisional application No. 61/886,111, filed on Oct. 3, 2013.

(51) Int. Cl. A01M 31/00; A01M 31/06

(52) U.S. Cl. CPC A01M 31/004; A01M 31/06; A01M 31/002
USPC 119/719

(57) ABSTRACT

A mobile electronic call and decoy device is disclosed herein. The disclosed device generally comprises a mobile carrying unit, a sound dampening body attached to the mobile carrying unit, and an electronic call unit attached to the mobile carrying unit, wherein the mobile carrying unit and the electronic call unit are remotely-operable.

### CROSS-REFERENCE TO RELATED APPLICATIONS

This application is related to and claims priority from earlier filed U.S. Provisional Patent Application No. 61/886,111, filed Oct. 3, 2013, the disclosure of which is incorporated herein by reference.

### BACKGROUND OF THE INVENTION

1. Field of the Invention

The present invention generally relates to a device for attracting animals to a particular area. More specifically, the present invention relates to a mobile electronic call and decoy device for luring animals to a predetermined area for observation or hunting purposes.

2. Description of Related Art

Currently, many different devices and accessories are available for attracting animals to a particular area for observation or hunting purposes. Such devices and accessories include game or predator calls, decoys, and cover scents or attractants. Problems experienced when utilizing current devices and accessories, however, present several disadvantages that are overcome by the present invention.

For many years, hunters and wildlife enthusiasts have used game or predator calls to lure animals to desired areas. These devices include manual calls such as rattling horns, rattling bags, reed calls, diaphragm calls, pot calls, box calls, etc. A fundamental problem of manual calls is the specific and precise techniques required for properly operating the calls. The inability to properly operate these manual calls can be incredibly frustrating to users and can render the calls useless. Additionally, operating many of these manual calls requires significant movement by a user, which often alerts approaching animals to the user's presence and scares away the animals. Furthermore, even though a hunter may be able to attract an animal with a manual call, rather than leading the animal to a predetermined area within firearm range of the hunter, the sound coming from the hunter will lead the animal to the hunter's exact location. Then, upon detecting the hunter's scent or presence, the approaching animal will immediately flee, causing the hunter to miss his or her opportunity to fire at the targeted prey.

In response to the limitations of manual calls, electronic calls were developed, which produce a range of call noises to attract game and predators to a predetermined area. Electronic calls typically include a recorded sound player, amplifier and loudspeaker, and are configured to be remotely operable by using a hand-held remote control. Unlike manual calls, little skill is required to operate an electronic call. On the other hand, electronic calls have several disadvantages that limit the effectiveness of such devices. For example, to utilize an electronic call, a hunter must walk into a field or hunting territory and manually place the call in the particular location to which the hunter desires to lure an animal. Once the hunter returns to his or her hunting position, if the hunter wishes to relocate the call, the hunter must walk back into the hunting territory to retrieve and move the call. In placing or moving the call, the hunter risks being seen, smelled or otherwise detected by an approaching animal. Additionally, since the call device is positioned remotely from the user, it is difficult to obtain status or other information on the device. The user must walk to the call device and inspect it to determine whether or not the device is operating properly, has sufficient battery life, etc. Regularly performing such diagnostic checks of the call device wastes the user's time and energy, and risks alerting animals to the user's presence and scaring off the animals.

Another device often used to attract animals to a particular area for observation or hunting purposes is a decoy device. A wide variety of decoy devices are available as lures for hunting or to attract wildlife for observation or study. Decoy devices are plagued by many of the same drawbacks experienced with call devices. Most notably, current decoy devices are not made to be mobile. Rather, such devices are set up in a fixed location to attract animals to the decoy's stationary position. Therefore, when setting up or moving the decoy, a user risks being detected by an animal and scaring the animal away.

Another accessory often used by hunters and wildlife enthusiasts is a cover scent or attractant. A problem that plagues all hunters and wildlife enthusiasts is being detected by an animal's keen sense of smell. To mask their own natural scents and to increase their chances of being in the presence of wildlife, hunters and wildlife enthusiasts often spray or rub cover scents or attractants on themselves. These scents are made from substances that produce a pungent and unpleasant odor (e.g., doe urine, buck urine, coyote urine, skunk oil, etc.). Not surprisingly, many hunters and wildlife enthusiasts do not particularly enjoy wearing and smelling such foul odors on themselves.

In addition to the devices and accessories noted above, hunters and wildlife enthusiasts often use additional gear and accessories, such as location monitors (e.g., global positioning systems or “GPS” devices), for the observation or hunting of wildlife. Carrying all these separate devices is overly cumbersome for users and it is very difficult to coordinate operation of a plurality of separate devices, particularly when out in the field and when time is of the essence.

Currently, a need exists for a remotely-operable and mobile electronic call and decoy device for attracting animals to a predetermined area for observation or hunting purposes. An all-in-one device, including an electronic call unit, decoy, and scent emitting unit is needed that is convenient to transport into a field or wildlife territory and that is easy to operate. Unlike existing immobile call and decoy devices, a device that is mobile and remotely-operable is needed that allows a user to remain hidden and undetectable by animals approaching the device. Additionally, there is a need for a device that does not require excessive movement by the user for operation of the device, as such movement discloses the user's presence and scares away animals. Finally, a device is needed that attracts animals to a location remote from the user so that the user does not have to wear foul cover scents on the user's own body.

In view of the foregoing, it is apparent that a need exists in the art for a mobile electronic call and decoy device which overcomes, mitigates or solves the above problems in the art. It is a purpose of this invention to fulfill this and other needs in the art which will become more apparent to the skilled artisan once given the following disclosure.

### OBJECTS AND SUMMARY OF THE INVENTION

It is an object of the present invention to overcome the above described drawbacks associated with current devices. To achieve these and other advantages and in accordance with the purpose of the invention, as embodied and broadly described, the present disclosure describes a mobile electronic call and decoy device.

By utilizing a remotely-operable, radio controlled system, the disclosed device utilizes sound, scent, and/or visual decoys to attract animals to a predetermined area, while allowing a user to remain practically motionless, hidden, and far away from the device to prevent detection of the user by approaching animals. The device generally comprises a mobile carrying unit, an electronic call unit, and a sound dampening body, wherein the mobile carrying unit and the electronic call unit are remotely-operable.

The remotely-operable mobile carrying unit provides numerous advantages to the device. The mobile carrying unit utilizes a waterproof motor, waterproof electronics, multi-terrain tires, a lightweight yet rigid chassis, and remote locking differentials, to allow the mobile unit to drive over wet, muddy and even snow-covered terrains. By attaching an electronic call unit, decoy device and/or a scent emitting device to the mobile carrying unit, the device is able to attract animals to a predetermined area for hunting or observation purposes without alerting approaching animals to the presence of the user.

An electronic call unit may be mounted to the mobile carrying unit to provide many advantages to the disclosed device. By making the electronic call mobile and remotely operable, a user can lure animals to a desired location while remaining hidden and undetectable by animals approaching the mobile call device. Additionally, the user can remotely move the device and attract wildlife to different locations without scaring away the animals.

Further advantages are provided by the sound dampening body of the disclosed device. The sound dampening body muffles the sounds of the mobile carrying unit and attached parts, such as the sounds of the motor and vibrations of the parts attached to the mobile carrying unit. Additionally, the sound dampening body may be camouflaged as a decoy device to visually attract animals to the device. For example, fur, paint, animal-like ears or a tail, or another disguise can be adhered to or applied to the sound dampening body to camouflage the body as a decoy device. By providing a mobile decoy device, the disclosed device appears more lifelike to approaching animals compared to current immobile devices.

Still another advantage of the presently disclosed device is that the device may further include a scent emitting device able to remotely spray an attractant in a hunting or wildlife territory. The remotely sprayed attractant lures animals to a location within firearm range of users and prevents the users from having to douse themselves in foul-smelling scents.

Another advantage is provided by a motorized tail member which may be included with the disclosed device. The motorized tail utilizes a remotely-operable servo for rotating the tail. By rotating the tail member, the motorized tail member is able to upright the device in the event it is flipped on its side. Additionally, the motorized tail member is able to dislodge the device in the event it becomes stuck or high-centered. The tail member may be camouflaged as a decoy device to visually attract animals to the mobile device. For example, the tail member may include a spring-mounted ball attached to the distal end of the tail and the tail may include a covering (e.g., a fur sleeve covering or the like) to further disguise the tail. The tail member may further include a receiver antenna contained within the tail member. The receiver antenna can be an extended antenna to provide for increased range for receiving radio frequency signals from a transmitter unit.

Additional accessories may be attached to the mobile carrying unit to provide further advantages to the disclosed device. For example, the mobile carrying unit may include an infrared flashing light attached thereto. Infrared light is not visible or detectable by attracted wildlife, but allows a user to easily locate the device using an infrared detecting device (e.g., night-vision goggles). Additionally, the mobile carrying unit may include a location monitoring unit (e.g., a GPS device) attached thereto to allow the user to easily locate the device, especially when the device is used in dark settings, tall brush, or other environments that make the device difficult to see. The location monitoring unit can also be used to establish the geographical coordinates and the elevation at the device's location, which will allow a user to calculate the distance and change in elevation from the user to a targeted animal. Another accessory that may be attached to the mobile carrying unit is an atmospheric monitoring device that measures wind speed, wind direction, and barometric pressure. Furthermore, a camera providing video and/or still images may be attached to the mobile carrying unit. The images can be projected to a handheld transmitter unit to allow the user to constantly monitor the immediate surroundings of the mobile carrying unit.

Further advantages are provided by the transmitter unit of the disclosed device. In one embodiment, the device may use a single transmitter unit which controls movement, speed, direction, acceleration, and starting and stopping of the mobile carrying unit, as well as operation of the attached accessories. For example, in addition to operating the mobile carrying unit, the transmitter unit can be configured to operate the electronic call, including the speaker volume and the specific call sound playing; it can display GPS coordinates and the elevation of the device relative to the transmitter unit to calculate distance and change in elevation to a targeted animal; it can display atmospheric values including wind direction, wind speed, and barometric pressure; it can display video and still images captured by the camera on the device; and it can display the remaining battery life of the device. In another embodiment, the device may include at least two transmitter units, one for operating the mobile carrying unit and the other for operating the accessories attached to the mobile carrying unit. In such an embodiment, one user could drive and navigate the mobile carrying unit while another user operates the accessories, such as the electronic call unit and scent emitting unit. Also, by extending the transmitter antenna on the transmitter unit and/or the receiver antenna on the mobile carrying unit, the range of communication between the transmitter unit and mobile carrying unit can be increased to operate the mobile carrying unit and attached electronic accessories from much greater distances compared to the range of communication provided by existing devices.

The disclosed device also provides the advantage of being easy to transport from one location to another. Currently, hunters are forced to lug around a plurality of separate hunting or tracking devices. The disclosed device provides an all-in-one device that is easy to carry using the attached handle. The handle is uniquely configured to decrease the likelihood of the handle catching and getting stuck on objects such as a barbed-wire fence. By utilizing a unique configuration for the handle, as is disclosed herein, the handle is able to direct barbed wire and similar materials over the top of the mobile device to allow the device to travel underneath fences and similar barriers.

These, together with other objects of the invention, along with various features of novelty that characterize the invention, are pointed out with particularity in the detailed description and claims annexed hereto and forming a part of this disclosure. For a better understanding of the invention, its operating advantages, and the specific objects attained by its uses, reference should be had to the accompanying drawings and descriptive matter in which there is described illustrative embodiments of the invention.

### BRIEF DESCRIPTION OF THE DRAWINGS

The accompanying drawings, which are incorporated in and forma part of the specification, illustrate embodiments of the present invention, and together with the description, serve to explain the principles of the invention. It is to be expressly understood that the drawings are for the purpose of illustration and description only and are not intended as a definition of the limits of the invention.

In the drawings:

FIG. 1 is a side elevation view of a device constructed in accordance with the teachings of the present disclosure.

FIG. 2 is a front elevation view of the device shown in FIG. 1.

FIG. 3 is a rear elevation view of the device shown in FIG. 1.

FIG. 4 is a top plan view of the device shown in FIG. 1.

FIG. 5 is a side elevation view of a transmitter unit constructed in accordance with the teachings of the present disclosure.

### DETAILED DESCRIPTION OF ILLUSTRATIVE EMBODIMENTS

The terms “top,” “bottom,” “front,” “rear” and the like are used in the specification to describe an embodiment of the invention as illustrated in the accompanying Figures. It should be appreciated that in actual use, an embodiment of the invention may be rotated as needed to accomplish the objectives of the invention. As a result of such rotation, the various terms used herein of “top,” “bottom,” “front,” “rear,” and the like may not literally apply to a particular arrangement. Such terms are relative and are used herein to describe the Figures for illustration purposes only and are not intended to limit the embodiments shown to any particular orientation.

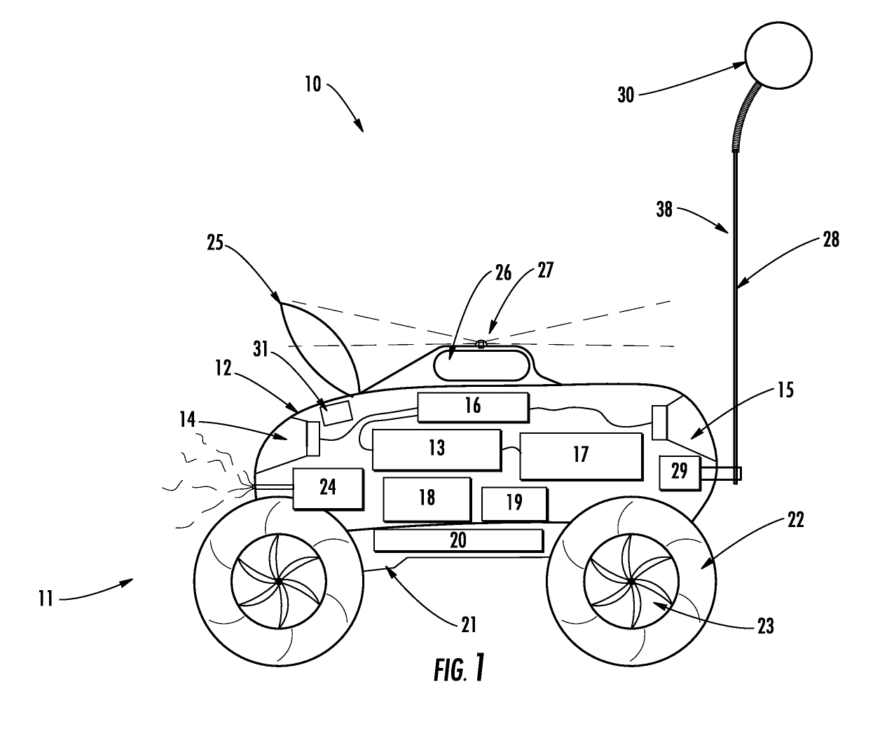

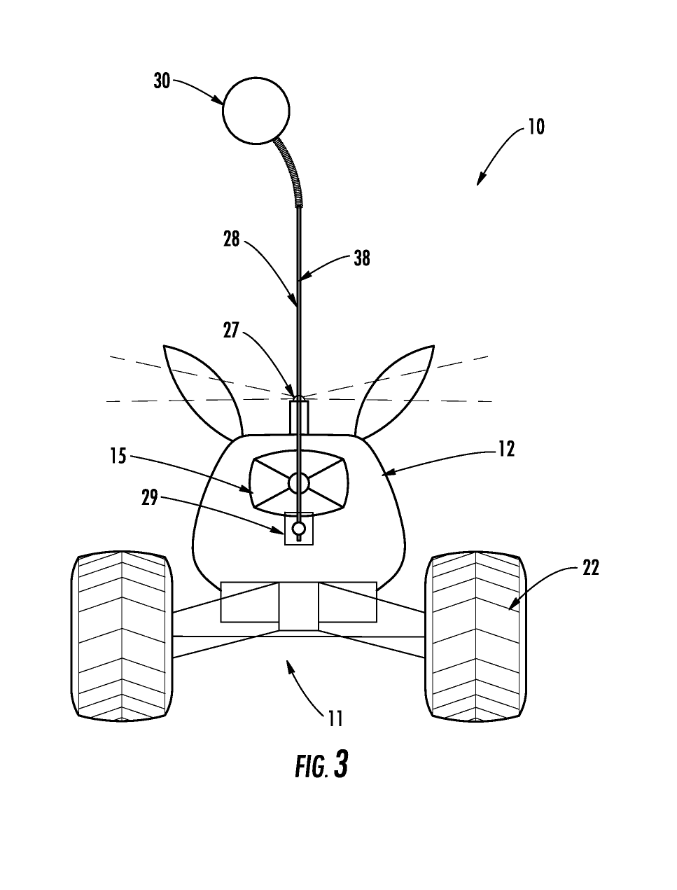

Referring now to FIGS. 1-5, exemplary embodiments of a mobile electronic call and decoy device 10 in accordance with the present disclosure are illustrated. In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, in some cases, specific details have been omitted inasmuch as such details are not considered necessary to obtain a complete understanding of the present invention, and are considered to be within the understanding of persons of ordinary skill in the relevant art.

Turning to FIG. 1, a device 10 according to the present disclosure is illustrated and generally includes a mobile carrying unit 11; an electronic call unit 13; and a sound dampening body 12; wherein the mobile carrying unit 11 and the electronic call unit 13 are remotely-operable.

The mobile carrying unit 11 generally includes a chassis 21, wheels 23, tires 22, a power supply 20, remotely-operable components 18, and an electric motor 19. The mobile carrying unit 11 may be built from the ground up to include such parts necessary for proper operation. In an alternative embodiment, the mobile carrying unit 11 is a radio-controlled (“RC”) vehicle having the car- or truck-shaped body portion of the vehicle removed. The chassis 21 of the mobile carrying unit 11 defines a lightweight, rigid base that provides for attachment of various parts and accessories. Such parts and accessories may be attached directly to the chassis 21 or attached to a platform mounted to the chassis 21.

The remotely-operable components 18 of the mobile carrying unit 11 include receivers 18 for wirelessly receiving information from a user-operated transmitter unit 32, and remotely actuated motors (e.g., servos) 18 for controlling the various parts of the mobile carrying unit 11 and attached accessories. For example, the remotely actuated motors 18 control the steering, locking differentials, and transmission of the mobile carrying unit 11, as well as operation of a scent emitting unit 24 and a motorized tail member 28 which may be attached to the mobile carrying unit 11.

The remotely-operable receivers 18 are communicatively coupled with a transmitter unit 32. A user may employ the transmitter unit 32 to provide control input to the mobile carrying unit 11 and attached accessories. For example, the user can manipulate the transmitter unit 32 to remotely control movement, speed, direction, acceleration, starting and stopping of the mobile carrying unit 11. The transmitter unit 32 includes an transmitter antenna 33 for transmitting user input to the receivers 18, and the receivers 18 are coupled with one or more receiver antennas 38 for receiving user input from the transmitter unit 32. In one preferred embodiment, the transmitter unit 32 and receivers 18 communicate via radio frequency signals which are transmitted from the transmitter antenna 33 to the receiver antennas 38. In alternative embodiments, the transmitter unit 32 and receivers 18 are able to communicate using any communication media known to those skilled in the art.

The disclosed device 10 includes a receiver 18 for operating the mobile carrying unit 11. The receiver 18 for operating the mobile carrying unit 11 is coupled to an electric motor 19. In the embodiment shown in FIG. 1, the electric motor 19 is powered by a power supply 20 attached to the chassis 21. The motor 19 is controlled by a receiver 18 and actuated by a remotely-located handheld transmitter unit 32. The power supply 20 provides the motor 19 with power and the motor 19 is configured to manage the magnitude of average power supplied to the motor 19 in response to the user input from the receiver 18. The power supply 20 may be a lithium polymer battery or any other rechargeable or non-rechargeable battery. In other embodiments, a charging port may be provided to allow the mobile carrying unit 11 to be plugged into an electrical wall outlet as an alternative power source.

The disclosed device 10 further comprises an electronic call unit 13 which may be attached to the chassis 21 of the mobile carrying unit 11. In the embodiment shown in FIG. 1, the electronic call unit 13 includes a recorded sound player (e.g., a digitally recorded sound player), an amplifier 16, a front audio speaker 14, a rear audio speaker 15, and a power supply 17. In one preferred embodiment, the recorded sound player of the electronic call unit 13 is an MP3 player, wherein sound files of game calls are stored in memory in a compressed digital format. The output of the recorded sound player is an audio signal. The audio signals are output to the amplifier 16, which in turn drives the speakers 14 and 15 that produce the sound. As illustrated in FIG. 1, the amplifier 16 connects the recorded sound player 13 to the speakers 14 and 15.

The electronic call unit 13 is preferably configured to store a plurality of game calls in digital memory, and the user can remotely select and determine which calls to play using the transmitter unit 32. Game calls are defined herein as sounds that animals may find attractive, including mating calls, sounds made by distressed animals, background animal sounds, and other naturally occurring sounds. Additionally, a game call may comprise a non-naturally occurring sound that is attractive to animals.

The electronic call unit 13 includes speakers 14 and 15 for projecting the sounds of the recorded game calls. Although the accompanying Figures illustrate the device 10 as having a front audio speaker 14 and a rear audio speaker 15, one skilled in the art can appreciate that the device 10 can be configured with only one speaker or with more than two speakers. The speakers 14 and 15 may be disposed within the sound dampening body 12, in which case the sound dampening body 12 may include apertures and/or louvers for permitting sound waves to pass through the body 12. Such apertures or louvers would be arranged and configured to allow sound waves to pass therethrough. Louvers would provide a barrier to protect the speakers 14 and 15 from direct physical contact and could be configured to direct liquid away from the speakers 14 and 15. Alternatively, the speakers 14 and 15 may be disposed fully or partially outside the sound dampening body 12, in which case the speakers 14 and 15 may include a waterproofing member to protect the speakers 14 and 15 from wet environments.

The electronic call unit 13 further includes a power supply 17, such as one or more rechargeable batteries or non-rechargeable batteries. As depicted in FIG. 1, the electronic call unit 13 may include a power supply 17 separate from the power supply 20 of the mobile carrying unit 11. In an alternative embodiment, rather than having a separate power supply 17 for the electronic call unit 13, the call unit 13 can be configured to receive power from the power supply 20 of the mobile carrying unit 11.

The disclosed device 10 further includes a sound dampening body 12 attached to the mobile carrying unit 11. In order to attach the sound dampening body 12 to the mobile carrying unit 11, the chassis 21 of the mobile carrying unit 11 may include mounting posts for attachment of the sound dampening body 12. The mounting posts define small projections, which may be formed at the front, rear and/or sides of the chassis 21, that match up with holes or slots formed in the sound dampening body 12. Each mounting post may further include at least one small aperture therethrough. After attaching the holes formed in the sound dampening body 12 to the mounting posts projecting from the chassis 21, a small pin can be inserted through the aperture formed in each mounting post to securely mount the body 12 to the chassis 21. Alternately, the sound dampening body 12 could include the mounting posts and the chassis 21 could include holes or slots formed therethrough for receiving the mounting posts. Other methods of attaching the sound dampening body 12 to the chassis 21 are available and will be appreciated by those skilled in the art and, therefore, are considered to be within the spirit and scope of the present invention.

The sound dampening body 12 is configured to muffle the sounds of the mobile carrying unit 11 and attached parts, such as the sounds of the motor 19 and vibrations of the parts and accessories attached to the mobile carrying unit 11. In order to decrease such noise, which could scare away approaching animals, the sound dampening body 12 may include several layers of different materials. For example, the sound dampening body 12 may include one or more of the following layers of materials: a first outer layer made of a material that camouflages the device 10 as a decoy device (e.g., a material made of real or artificial animal skin or fur, especially a material such as rabbit fur or fur of another common prey animal); a second layer made of a durable material (e.g., a plastic material, such as a polycarbonate resin thermoplastic); a third layer made of a material that absorbs sound and resists noise and vibration (e.g., a foam material, such as a closed-cell foam material); and a fourth interior layer of a material to deflect sound towards the ground surface (e.g., a thin metallic material). Preferably, the sound dampening body 12 forms a substantially hollow body and mounts to the chassis 21 of the mobile carrying unit 11 in a manner which substantially covers the accessories and parts attached to the mobile carrying unit 11. One skilled in the art can appreciate that the sound dampening body 12 may be provided in various configurations suitable for muffling the sounds of the mobile carrying unit 11 and vibrations of the attached accessories, all of which configurations are considered to be within the spirit and scope of the present invention.

As briefly mentioned above, the sound dampening body 12 may be camouflaged as a decoy device to visually attract animals to the device 10. For example, animal-like fur, ears, a tail, paint, or another disguise can be adhered to or attached as an outer layer of the sound dampening body 12 to camouflage the body 12 as a decoy device. In FIGS. 1-3, the device 10 includes ears 25 (e.g., rabbit ears or ears of another common prey animal), as well as a tail member 28 having a movable spring-mounted ball 30 attached to the distal end of the tail member 28. The spring provides movement to the ball 30 to make it appear more lifelike. The spring-mounted ball 30 could be replaced with various other attachments such as a flag or any other attachment that may be visually attractive to approaching animals. Additionally, the tail member 28 itself may include a covering (e.g., a fur-covered sleeve or the like) to further disguise the tail member 28.

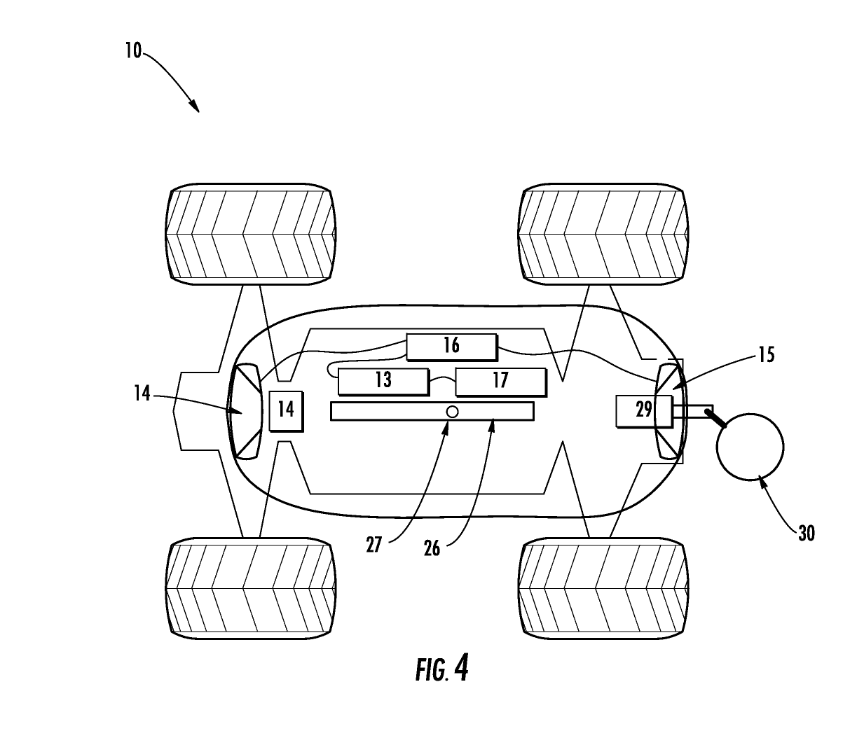

FIGS. 1 and 4 illustrate a handle 26 which is attached to the sound dampening body 12. The handle 26 can be configured in various ways in order to allow a user to easily carry the device 10 into a wildlife or hunting territory. As shown in FIG. 1, the front portion of the handle 26 may be tapered to decrease the likelihood of the handle 26 catching and getting stuck on objects such as a barbed-wire fence. Such a configuration allows the handle 26 to direct barbed wire and similar materials over the top of the mobile device 10 to allow the device 10 to travel underneath fences and similar barriers.

The disclosed device 10 further includes a receiver antenna 38 for receiving signals from a transmitter antenna 33. FIGS. 1-3 depict the receiver antenna 38 contained within a motorized tail member 28. In one preferred embodiment, the receiver antenna 38 is an extended antenna to provide for increased range for receiving radio frequency signals from the transmitter unit 32. It should be appreciated that the receiver antenna 38 may be incorporated into the mobile carrying unit 11 rather than protruding therefrom. Additionally, the disclosed device 10 may include a plurality of antennas to accommodate additional features, such as a location monitoring unit 31.

The device 10 may further include a motorized tail member 28 that is coupled to a remotely actuated motor (e.g., a servo) 29 for rotating the tail member 28. Actuation of the remotely actuated motor 29 is controlled from a remote location by means of a hand-held transmitter unit 32 communicating with a receiver attached to the mobile carrying unit 11. Upon receiving a command from the transmitter unit 32, the remotely actuated motor 29 is configured to rotate the tail member 28. In one preferred embodiment of the disclosed device, the rotating tail member 28 is able to upright the device 10 in the event the device 10 is flipped on its side. In another preferred embodiment, the rotating tail member 28 is able to dislodge the device 10 in the event the device 10 becomes stuck or high-centered. The tail member 28 may be made of a rigid metallic material or any other material able to provide enough strength to allow the tail member 28 to be used for uprighting or dislodging the device 10. As explained above, the tail member 28 may be camouflaged as a decoy device to visually attract animals to the mobile device 10.

As depicted in the attached Figures, the disclosed device 10 may further include a scent emitting unit 24, which emits a scent to attract animals towards the device 10. In one embodiment, the scent emitting unit 24 is defined as an aerosol canister or other appropriate container configured to release a scent. The scent contained in the scent emitting unit 24 may be urine, blood, pheromones, or any other scent suited to the animal being attracted or hunted. The scent emitting unit 24 may be coupled to a remotely actuated motor that depresses a nozzle or the like of the scent emitting unit 24 to release the scent contained in the scent emitting unit 24. One of the remotely actuated motors 18 used for operation of the mobile carrying unit 11 (e.g., for the steering, locking differentials, transmission, or motorized tail member 28 of the mobile carrying unit 11) may also be used to operate the scent emitting unit 24. Or, a separate remotely actuated motor may be included for operation of the scent emitting unit 24. As with all the remotely actuated motors included with the present device 10, actuation of the remotely actuated motor for operating the scent emitting unit 24 is controlled from a remote location by means of a hand-held transmitter unit 32 which communicates with receivers mounted to the mobile carrying unit 11. Once a receiver receives the proper command, the remotely actuated motor is actuated, forcing the scent emitting unit 24 to spray a certain amount of scent product from the scent emitting unit 24 through an aperture formed in the sound dampening body 12. The aperture for the scent emitting unit 24, which is formed in the sound dampening body 12, permits the scent to spray through the aperture into the area surrounding the mobile device 10. Alternatively, automatic timing mechanisms on-board the device 10 may be employed to release the scent at timed intervals set by the user.

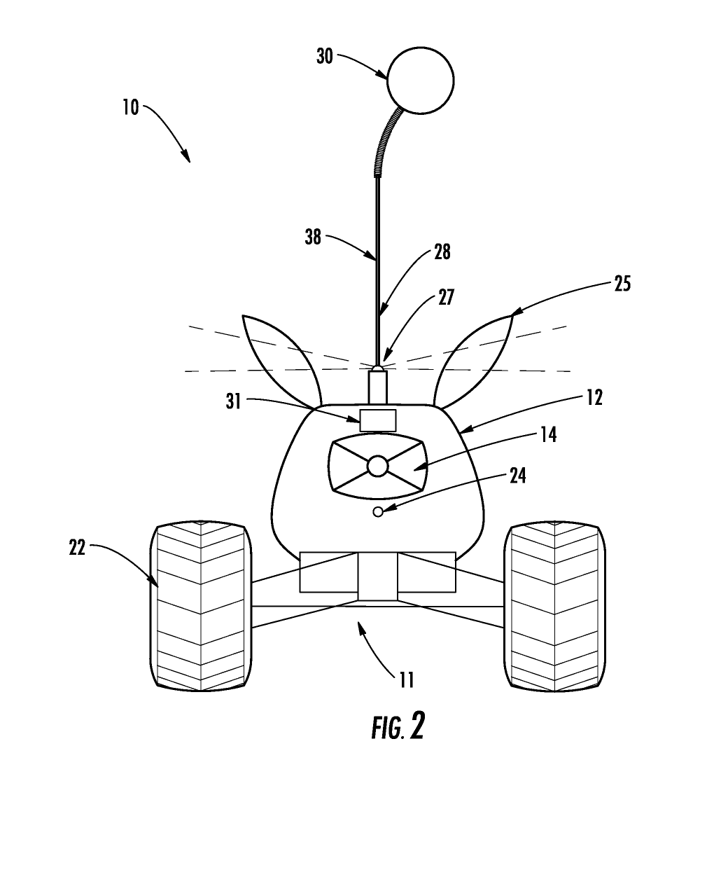

As shown in the accompanying Figures, the disclosed device 10 may include additional accessories. As shown in FIGS. 1 and 2, the disclosed device 10 may further include a location monitoring unit 31, such as a global positioning system (“GPS”) unit. The location monitoring unit 31 is used to establish the geographical coordinates and the elevation at the mobile device's 10 location to allow a user, such as a hunter, to calculate the distance and the change in elevation from the user to a targeted animal. The disclosed device 10 may further include an infrared light 27 attached thereto. As shown in FIGS. 1-3, a flashing infrared light 27 may be attached to a top portion of the device 10 to allow a user to easily locate the device 10 using an infrared detecting device, such as night-vision goggles. The device 10 may further include an atmospheric monitoring unit that measures wind speed, wind direction and barometric pressure, as well as electronics to allow the atmospheric values to be displayed remotely on a display 37 of the transmitter unit 32.

Though not depicted in the attached Figures, the device 10 may further include a camera attached to the mobile carrying unit 11. In one embodiment, the camera is generally contained within the sound dampening body 12 of the device 10 such that a lens of the camera is flush with the outer surface of the body 12. In other versions, the lens of the camera may protrude or be recessed from the outer surface of the body 12. The camera may be a digital camera able to capture images, such as photographs and video. In certain embodiments, the camera may store the images on any suitable image storage media. Additionally, the camera may include a receiver which is communicatively coupled to the transmitter unit 32, so that digital pictures and/or video may be sent to the transmitter unit 32 to be viewed on a display of the transmitter unit 32. The pictures and/or video may also be sent to a computer, cell phone, or any other communication device having a graphic display capable of viewing images, or to a display device capable of receiving the images. Still further, images may be automatically downloaded to a database for immediate or subsequent viewing.

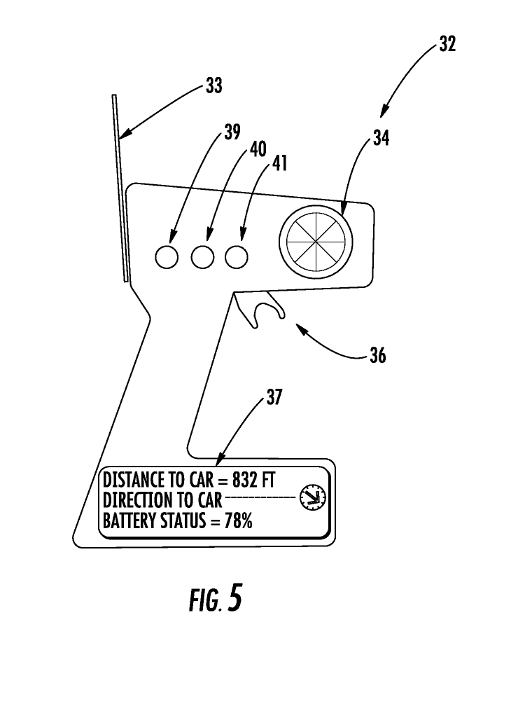

Turning to FIG. 5, the disclosed device 10 further includes a transmitter unit 32 for remotely operating and communicating with the mobile carrying unit 11 and attached accessories. The transmitter unit 32 may include a transmitter antenna 33; a steering member 34 for steering the device 10; an electronic call unit control 39; a scent emitting unit control 40; a tail member control 41; a throttle 36; an information display screen 37; and a power supply (e.g., one or more rechargeable batteries or non-rechargeable batteries). In other embodiments, the transmitter unit 32 may incorporate additional features such as a display screen for viewing images or video captured from a camera attached to the mobile carrying unit 11, a digital compass, a location monitoring unit, a battery life indicator, and/or a link for a cellular telephone.

The handheld transmitter unit 32 is communicatively coupled with the receivers 18 on the mobile carrying unit 11. The transmitter unit 32 includes a transmitter antenna 33 for transmitting user input to the receivers 18. The receivers 18 include a receiver antenna 38 for receiving the user input from the transmitter unit 32. In one embodiment, the transmitter unit 32 communicates with the mobile carrying unit 11 and attached accessories (e.g., electronic call unit, motorized tail, scent emitting unit, location monitoring unit, atmospheric monitoring device, and camera) via radio frequency signals which are transmitted from the transmitter antenna 33 to the receiver antenna 38. The transmitter antenna 33 and/or the receiver antenna 38 can be lengthened to increase the range of communication between the transmitter unit 32 and the mobile carrying unit 11 to provide for operation of the mobile carrying unit 11 and attached electronic accessories from much greater distances than the range provided by conventional electronic call devices and RC vehicles.

In response to incoming signals sent by the transmitter unit 32, the receiver 18 is configured to execute one or more commands carried by the signal. The commands may relate to the operation of the mobile carrying unit 11, such as drive forward, drive in reverse, drive faster, drive slower, stop, turn, etc. Other commands may relate to the operation of the electronic call unit 13, such as to raise or lower the volume of the speakers 14 and 15, to select the particular game call that is to be sounded, to repeat a particular game call, to combine two or more game calls to generate a unique sequence of calls, to turn the call unit 13 on or off, or to perform another function. Other commands may relate to the operation of the motorized tail member 28, such as to rotate the tail 28. Still other commands may relate to the operation of the scent emitting unit 24, such as to spray the scent.

It should be appreciated that communication systems and/or protocols, other than communication via radio frequency signals, may be employed to establish communication between the transmitter unit 32 and the mobile carrying unit 11 and attached accessories. For example, the transmitter unit 32, mobile carrying unit 11 and attached accessories may utilize other forms of communication such as a cellular phone network, satellite transmission, Bluetooth, or other communication methods, protocols, and frequencies. Additionally, it should be appreciated that the transmitter unit 32 may be defined as a cellular telephone (e.g, a smart phone) that has an application for a remote control function.

The transmitter unit 32 includes a user interface in the form of a plurality of controls (e.g., 34, 36, 39, 40 and 41) which may protrude from the surface of the transmitter unit 32. In other embodiments, the controls may be recessed or flush with the surface of the transmitter unit 32 or may be incorporated into a touchscreen display, in which case the controls may be actuated by touching the display to select certain controls. In one preferred embodiment, the user interface includes both controls and an information display 37. The information display 37 provides information to the user such as a list of call sounds available, the volume level of the call, the level of battery charge, and the distance to the mobile device 10. The controls allow a user to select a desired action, such as selecting the desired call, adjusting the call volume, driving and steering the mobile device 10, spraying a scent, and rotating the tail member 28.

In one embodiment, the device 10 may use a single transmitter unit 32 which controls movement, speed, direction, acceleration, starting and stopping of the mobile carrying unit 11, as well as operation of the attached accessories. For example, in addition to operating the mobile carrying unit 11, the transmitter unit 32 can be configured to operate the electronic call unit 13; it can display geographic coordinates and elevation of the mobile device 10 relative to the transmitter unit 32 to calculate distance and change in elevation to a targeted animal; it can display atmospheric values including wind direction, wind speed, and barometric pressure; it can display video and still images captured by the camera on the device 10; and it can display the remaining battery life of the mobile device 10. In another embodiment, the device 10 may include at least two transmitter units, one for operating the mobile carrying unit 11 and the other for operating the accessories attached to the mobile carrying unit 11. In such an embodiment, one user could drive and navigate the mobile carrying unit 11 while another user operates the accessories, such as the call unit 13 and scent emitting unit 24.

It is important to note that the construction and arrangement of the elements of the device provided herein are illustrative only. Although only a few exemplary embodiments of the present invention have been described in detail in this disclosure, those skilled in the art who review this disclosure will readily appreciate that many modifications are possible in these embodiments (such as variations in orientation of the components of the system, sizes, structures, shapes and proportions of the various components, etc.) without materially departing from the novel teachings and advantages of the invention.

Though the disclosed device is primarily described with its application for use with hunting wildlife, note that it is not intended to limit the spirit and scope of the present invention solely for use in conjunction with hunting. The disclosed device may be employed by animal enthusiasts, wildlife photographers, recreational outdoorsmen, and outdoor researchers for attracting wildlife to a predetermined area. Additionally, the device may be used as a toy for pets or to induce exercise in pets, as pets will be drawn to chase the device. The device may also be used by farmers or ranchers to lure livestock to a particular area, such as a barn (e.g., by playing a call sound of a calf in distress). Alternatively, the device could be used to repel animals from certain areas.

Many other uses of the present invention will become obvious to one skilled in the art upon acquiring a thorough understanding of the present invention. Once given the above disclosures, many other features, modifications and variations will become apparent to the skilled artisan in view of the teachings set forth herein. Such other uses, features, modifications and variations are, therefore, considered to be a part of this invention, the scope of which is to be determined by the following claims.

The invention claimed is:

1. A mobile electronic call device, comprising:
a mobile carrying unit;
a sound dampening body attached to said mobile carrying unit; and
an electronic call unit attached to said mobile carrying unit;
wherein said mobile carrying unit and said electronic call unit are remotely-operable using a transmitter unit.

2. The device according to claim 1, wherein said mobile carrying unit comprises:
a chassis configured for attachment of accessories and configured for attachment of parts of said mobile carrying unit;
wheels connected to said chassis;
a power supply attached to said chassis;
one or more receivers configured to wirelessly receive information from said transmitter unit, said one or more receivers being attached to said chassis;
one or more remotely actuated motors configured to operate one or more of the parts of said mobile carrying unit and configured to operate one or more of the accessories attached to said mobile carrying unit, said one or more remotely actuated motors being attached to said chassis; and
a motor configured to operate said mobile carrying unit, said motor being attached to said chassis.

3. The device according to claim 2, wherein said accessories attached to said mobile carrying unit comprise accessories selected from a group consisting of said electronic call unit, a scent emitting unit, a location monitoring unit, an atmospheric monitoring device, and a camera.

4. The device according to claim 2, wherein said chassis of said mobile carrying unit includes mounting posts configured for attachment of said sound dampening body to said chassis.

5. The device according to claim 4, wherein said mounting posts define projections arranged and configured to attach to slots formed in said sound dampening body for attachment of said sound dampening body to said chassis.

6. The device according to claim 2, wherein sound dampening body includes mounting posts configured for attachment of said chassis to said sound dampening body.

7. The device according to claim 6, wherein said mounting posts define projections arranged and configured to attach to slots formed in said chassis for attachment of said chassis to said sound dampening body.

8. The device according to claim 2, wherein said sound dampening body is configured as a substantially hollow body, and wherein said sound dampening body attaches to said chassis in a manner which substantially covers said parts of said mobile carrying unit attached to said chassis and substantially covers said accessories attached to said chassis.

9. The device according to claim 2, further comprising a second transmitter unit, wherein said transmitter unit controls operation of said parts of said mobile carrying unit and said second transmitter unit controls operation of said accessories attached to said mobile carrying unit.

10. The device according to claim 2, further comprising:
a transmitter antenna attached to said transmitter unit, said transmitter antenna being configured to transmit user input to said one or more receivers; and
one or more receiver antennas coupled with said one or more receivers, said one or more receiver antennas being configured to communicate with said transmitter antenna.

11. The device according to claim 10, wherein said one or more receivers communicate with said transmitter unit via radio frequency signals transmitted from said transmitter antenna to said one or more receiver antennas.

12. The device according to claim 2, wherein said sound dampening body is disguised as a decoy device.

13. The device according to claim 12, wherein said sound dampening body includes one or more decoy disguises selected from a group consisting of animal skin, animal fur, artificial animal skin, artificial animal fur, ears, a tail, and paint.

14. The device according to claim 12, wherein said device includes a tail member having a moveable member attached to a distal end of said tail member.

15. The device according to claim 14, wherein said moveable member defines a spring-mounted ball attached to said tail member.

16. The device according to claim 1, wherein said mobile carrying unit defines a radio-controlled vehicle having the body portion of the vehicle removed.

17. The device according to claim 1, wherein said electronic call unit comprises:
a recorded sound player;
one or more speakers;
an amplifier connecting said recorded sound player to said one or more speakers; and
a power supply.

18. The device according to claim 17, wherein said one or more speakers are disposed within said sound dampening body, and wherein said sound dampening body includes apertures for permitting sound waves to pass through said sound dampening body.

19. The device according to claim 17, wherein said one or more speakers are disposed within said sound dampening body, and wherein said sound dampening body includes louvers for permitting sound waves to pass through said sound dampening body, said louvers being arranged and configured to provide a barrier to protect said speakers from direct physical contact and from liquids.

20. The device according to claim 17, wherein said one or more speakers include a waterproofing member to protect said speakers from liquids.

21. The device according to claim 17, wherein said power supply is configured to power said electronic call unit and said mobile carrying unit.

22. The device according to claim 1, wherein said sound dampening body comprises one or more layers of materials selected from a group consisting of:
a layer made of a material that disguises said device as a decoy device;
a layer made of a plastic material;
a layer made of a foam material that absorbs sound; and
a layer made of a metallic material.

23. The device according to claim 1, wherein said sound dampening body comprises at least two layers of materials selected from a group consisting of:
a layer made of a material that disguises said device as a decoy device;
a layer made of a plastic material;
a layer made of a foam material that absorbs sound; and
a layer made of a metallic material.

24. The device according to claim 1, further comprising a receiver antenna disposed within a motorized tail member, wherein said receiver antenna is configured to receive signals from a transmitting antenna of said transmitter unit.

25. The device according to claim 1, further comprising a receiver antenna disposed within said mobile carrying unit, wherein said receiver antenna is configured to receive signals from a transmitting antenna of said transmitter unit.

26. The device according to claim 1, further comprising a motorized tail member attached to said mobile carrying unit, said motorized tail member being coupled to a remotely actuated motor for rotating said tail member.

27. The device according to claim 1, further comprising a scent emitting unit that emits a scent to attract animals toward said device, wherein said scent emitting unit is coupled to a remotely actuated motor that is arranged and configured to force said scent emitting unit to release said scent contained within said scent emitting unit, and wherein actuation of said remotely actuated motor is controlled by said transmitter unit.

28. The device according to claim 1, further comprising an infrared light attached to said sound dampening body.

29. The device according to claim 1, wherein said transmitter unit further comprises:
a transmitter antenna;
a steering member for steering said mobile electronic call device;
an electronic call unit control;
a scent emitting unit control;
a tail member control;
an information display screen; and
a power supply.
